(19) United States
(12) Patent Application Publication
(10) Pub. No.: US 2008/0203299 A1
(43) Pub. Date: Aug. 28, 2008

(54) Charged Particle Beam Apparatus

(75) Inventors: Toshiaki Kozuma, Hitachinaka (JP); Yukio Yoshizawa, Hitachinaka (JP); Megumi Aizawa, Hitachi (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi High-Technologies Corporation, Tokyo (JP)

(21) Appl. No.: 12/037,459

(22) Filed: Feb. 26, 2008

(30) Foreign Application Priority Data
Feb. 28, 2007 (JP) 2007-048377

(51) Int. Cl. G01N 23/225; G21K 5/10

(52) U.S. Cl. 250/310; 250/442.11

(57) ABSTRACT

It is an object of this invention to improve contact precision and probe operability. This invention controls sample stage movement and probe movement on an observation image using a single coordinate system, thereby allowing positioning using a sample stage stop error as a probe control movement amount. This invention also figures out the position of the tip of a probe using the observation image and stores the coordinates of the probe at a reference position on the image. This invention facilitates precise probe contact operation to a sample position of the order of microns.

### BACKGROUND OF THE INVENTION

1. Field of the Invention

The present invention relates to a technique for extracting a piece of a sample including a desired area from a semiconductor wafer, a semiconductor device, or the like using ion beams.

2. Background Art

Manufacture of semiconductor devices such as a semiconductor memory and a microprocessor and electronic components such as a magnetic head requires characteristic inspection for product quality control. The characteristic inspection includes measurement of manufacturing dimension, inspection of a circuit pattern for a defect, and analysis of foreign bodies. Various means are prepared to perform these inspections. If an abnormality is found inside a product, a micromachining and observation apparatus using a focused ion beam (FIB) is used. This apparatus includes a function of cutting out a minute area of the order of microns including an observation part and producing a minute sample for facilitating observation inside and outside the apparatus (hereinafter, a minute sample will be referred to as a micro-sample, and a step of producing a micro-sample as micro-sampling). As a method for realizing the function, there has been devised and used a method for separating a micro-sample from an original sample by connecting the micro-sample to a needle-shaped probe and moving the position of the probe (JP Patent Publication (Kokai) No. 5-52721 A (1993)).

Positioning by probe drive control is important to separate a micro-sample from an original sample in micro-sampling. As a preliminary step for micro-sampling, a micro-sample needs to be brought to within an observation area by controlling to drive a stage. The position of a probe to be brought into contact with the micro-sample is determined by controlling to drive the probe. If an error occurs in both of the stage drive control and the probe drive control, it is necessary to manually adjust the position of the probe to that of the micro-sample while viewing an observation image.

A process of bringing a probe into contact with a micro-sample requires precise control of movement of the probe to a probe adhesion position of a small piece of several micrometers. This is because the process aims at connecting a micro-sample to the tip of a probe and separating the micro-sample from an original sample. Although movement of a sample stage by precise drive control is also important, it is not easy to always control to move the sample stage to a desired position, even allowing for the tolerance of a connection position of a micro-sample. Even if coordinate positioning by precise probe drive control is possible, coordinates for control of a probe drive control mechanism do not directly indicate the position of the tip of a probe. This is because a probe itself may be deformed or shortened in micro-sampling.

Conventional micro-sampling is work in a minute space, and the operability of a probe significantly affects operating precision and efficiency. Additionally, a heavy burden is placed on an operator due to the importance of a sample, the durability of a probe itself, and the like. For this reason, micro-sampling requires operational skill.

### SUMMARY OF THE INVENTION

The present invention has as its object to improve contact precision and probe operability.

The present invention controls sample stage movement and probe movement on an observation image using a single coordinate system, thereby allowing positioning using a sample stage stop error as a probe control movement amount. Also, the present invention figures out a position of a tip of a probe using the observation image and stores coordinates of the probe at a reference position on the image.

Preferably, positional information of the tip of the probe is acquired while observing the tip of the probe, and a coordinate system recognized by a probe drive control section is associated with the positional information.

Preferably, control of a position of the tip of the probe using a same coordinate system as a coordinate system of coordinates of a stage is allowed by associating the coordinates of the stage, on which a sample is mounted, with coordinates recognized by the probe drive control section.

Preferably, an operation of designating a direction and a magnitude on the observation image is performed using a pointing device, a position of the probe is changed by a same magnitude and in a same direction as the operation on the image, and the position of the probe is moved to a desired position while observing the tip of the probe on the image.

Preferably, a positional relationship between the position of the tip of the probe and the observation image is maintained, and measurement of a displacement and feedback of the displacement for coordinates of the probe are performed even if a shape of the tip of the probe changes due to factors including probe replacement, probe break, and probe deformation.

Preferably, a shape of the tip of the probe which has been deformed is shaped by precisely arranging the tip of the probe within an observation area and applying a charged particle beam to an area of a regular shape.

Preferably, recognition of the tip of the probe and association of the control section for stage driving with the coordinates recognized by the probe drive control section are automatically performed, and the association is held and used for probe control.

Preferably, a search area is limited based on the recognition of the tip of the probe and storage of the coordinates of the probe in tip recognition at another time.

Preferably, shift amounts in X and Y directions on the observation image are measured in advance at at least two heights, the degree of shift when controlling the probe to a target height is derived, and the probe is controlled to be driven to a target position based on the degree of shift.

Preferably, the probe is brought into contact with a surface of a minute sample, the tip of the probe is caused by deposition to adhere to the minute sample, a connection between the minute sample and a sample is cut, and the minute sample is picked up by controlling to drive the probe.

The present invention facilitates precise probe contact operation to a sample position of the order of microns.

### BRIEF DESCRIPTION OF THE DRAWINGS

FIG. 1 is a schematic view of a charged particle beam processing and observation apparatus having a probe drive control mechanism;

FIG. 2 is a schematic view showing how a micro-sample and the tip of a probe appear in an observation image area;

FIG. 3 is a flow chart showing an algorithm for correcting the position of the tip of a probe;

FIG. 4 is a flow chart showing an algorithm for probe alignment;

FIG. 5 is a schematic view showing the concept of pulling of a probe to a target position;

FIG. 6 is a schematic view showing a posture at the time of shaping the tip of a probe and processing patterns;

FIG. 7 is a schematic view showing the concept of a shift in probe Z movement;

FIG. 8 shows an example of a screen for setting conditions defining a probe contact position;

FIG. 9 shows an example of a screen for setting conditions defining a position at which a micro-sample is cut out from a sample; and

FIG. 10 shows an example of an operation screen for performing an automatic pickup process.

### DETAILED DESCRIPTION OF THE PREFERRED EMBODIMENTS

The foregoing and other novel features and advantages of the present invention will be described below with reference to the drawings. Note that the drawings are illustrative only and not intended to restrict the scope of right.

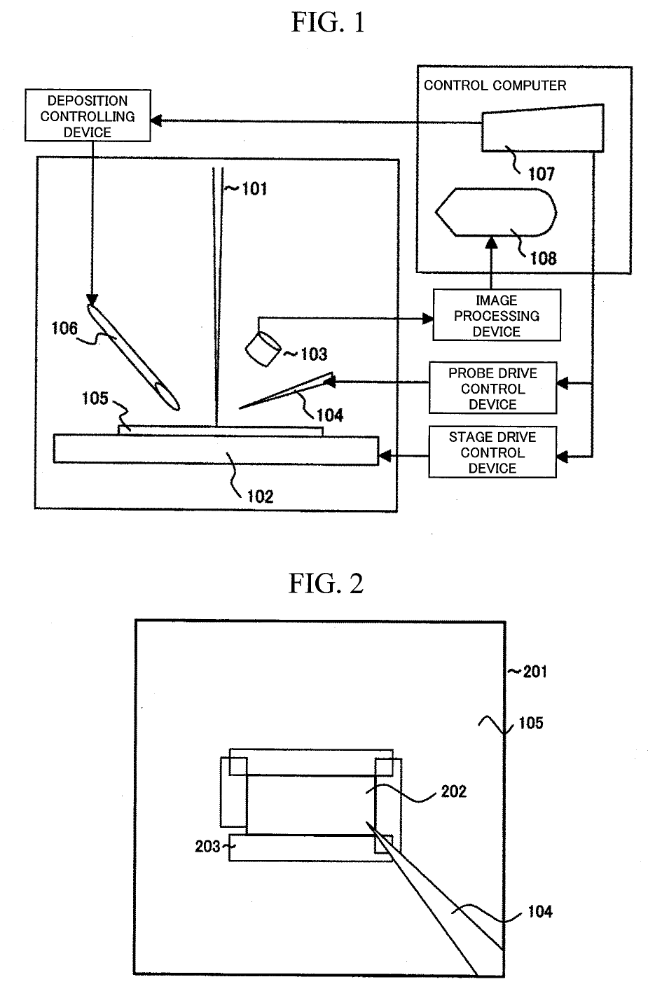

FIG. 1 is a schematic view of a charged particle beam processing and observation apparatus having a probe drive control mechanism and represents a unit pertaining to this embodiment of a mechanism constituting the processing and observation apparatus.

The apparatus includes a charged particle beam generating section, a charged particle beam irradiating optical system section, a stage on which a sample is mounted and which can move below a charged particle beam, a control section which drives the stage, an electron detecting section which detects a particle emitted from the sample, a control section which acquires an observation image by synchronizing a detection signal from the electron detecting section and charged particle beam scanning, a probe for cutting out a minute sample from a sample, and a drive control section which controls driving of the probe.

More specifically, reference numeral 101 denotes a focused ion beam for processing and observation. The processing and observation are performed by applying the focused ion beam 101 to a sample 105 while changing conditions for the beam 101. Since the deflectable range of the focused ion beam 101 is narrower than that of a sample stage 102, the sample stage 102 is moved through a stage controlling device in order to display a desired processing and observation position on the sample 105. The sample stage 102 has movable axes for horizontal directions X and Y and a movable axis which enables the sample stage 102 to form an angle allowing cutting of a bottom portion of a micro-sample with the focused ion beam 101. In some cases, a mechanism movable in the vertical direction of the beam or in the direction of rotation of the beam may be provided. The sample 105 is irradiated with the focused ion beam 101, and a secondary electron generated from the sample 105 is captured by a detector 103 and is displayed on an image display device 108 of a control computer through an image processing device. In the apparatus, a probe 104 necessary for micro-sampling and a deposition nozzle 106 which discharges gas necessary for deposition are respectively connected to the control computer through a probe controlling device and a deposition controlling device. An operator controls the probe 104 and deposition nozzle 106 using an input device 107 while referring to an image on the image display device 108.

FIG. 2 is a schematic view showing how a micro-sample and the tip of a probe appear in an observation image area and shows an example of a combination of the probe 104, a peripheral processing groove 203 for a micro-sample formed in the sample 105, and a micro-sample 202 within a single field 201 of view in an observation state. For illustrative purposes, the positional relationship between the micro-sample 202 and the probe 104 is such that the probe 104 is in contact with the micro-sample 202 at a position appropriate for later micro-sample separation. Note that a groove is formed in a bottom portion of the micro-sample 202 for later lifting while the sample stage 102 is tilted, and the bottom portion of the micro-sample 202 is in a sufficiently separable state as seen from a direction of observation. A processing margin is intentionally left at the lower left of the peripheral processing groove 203 to stabilize the micro-sample 202 when the probe 104 is brought into contact with the micro-sample 202. The processing margin is cut after the probe 104 is caused to adhere to the micro-sample 202. The probe 104 is directly attached to the probe drive control mechanism. Since deformation, shortening, or the like may occur in a probe itself in a micro-sampling process, a probe is considered to be an expendable item. In probe replacing work, the relationship between coordinates held by the probe drive control mechanism and a probe tip position varies depending on an attached probe state. For precise probe contact, it is necessary to know in advance the relationship between the probe tip position and the coordinates held by the probe drive control mechanism.

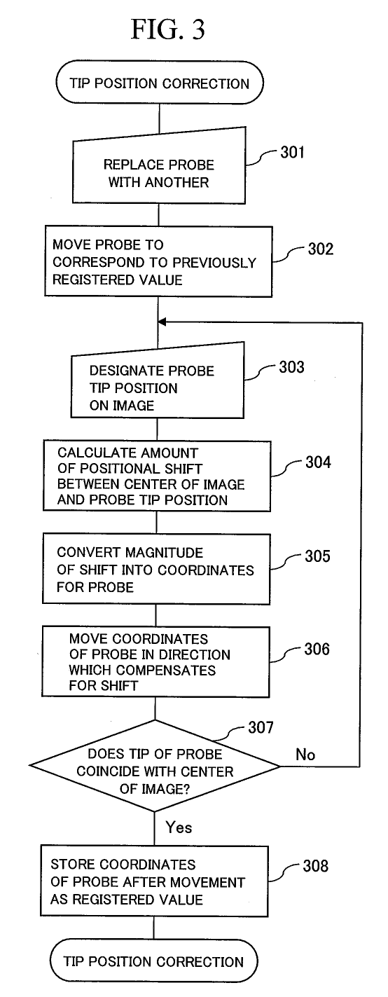

FIG. 3 is a flow chart showing an algorithm for correcting a probe tip position and shows an algorithm for correcting a tip position which has changed after probe replacement. First, a registered value for a probe is defined as the position of the tip of the probe when the tip falls at the center of the field 201 of view. A crossline passing through the center of the field 201 of view is drawn in advance on the field 201 of view to allow identification of the center. Movement of the probe is controlled such that the tip of the probe falls at a previously registered tip position (302). The position of the tip of the probe after the movement is off the center of the field 201 of view. The actual position of the tip of the probe on the field 201 of view is designated on the image display device 108 using the input device 107 (303). The amount of shift between the center of the field 201 of view and the designated point at this time is calculated (304). Since the calculated value indicates a magnitude on the image, it is converted into coordinates for the probe in consideration of the scaling factor of the field 201 of view, and a correction value is calculated (305). After that, the correction value is added to a current registered value, and the probe is moved (306). If the tip of the probe coincides with the center of the field 201 of view, the coordinate values at this time are stored as a new registered value. Otherwise, the processes in step 303 and subsequent steps are repeated.

The probe replacement work (301) in this algorithm means not only probe replacement. The work is performed as needed if shortening of a probe caused by a break, deformation in adhesion deposition, or the like occurs in the micro-sampling process.

The above-described series of processes is performed by an operator who is actually observing an image. However, if a probe tip position can be recognized on the field 201 of view without manual intervention, position adjustment can be automatically performed. In other words, the process 303 can be automated in the algorithm in FIG. 3. A method for the automation includes acquiring an image including the tip of a probe from an absorbed current image and binarizing each pixel of the image, acquiring a continuous area with a brightness of 1 (white) constituting the probe, and recognizing the maximum X and Y coordinates (the minimum X and Y coordinates in some coordinate systems) as the tip of the probe, as disclosed in JP Patent Publication (Kokai) No. 2000-171364 A (2000). If position correction is automatically performed, a shift from a previously registered value may be unnoticeable. Since a method for detecting the tip of a probe from the whole field of view (201) wastes processing time in this case, the scope of tip search is narrowed. A search area is dependent on an observation scaling factor, the magnitude of change from a previously registered value for a probe, and the like, and thus, it is stored in the control computer as variable data and used. A process of expanding the scope of search and performing a search again is incorporated with a case in mind where the tip of a probe cannot be detected in one search operation. Data for the expansion of the scope of search is also stored in the control computer and used.

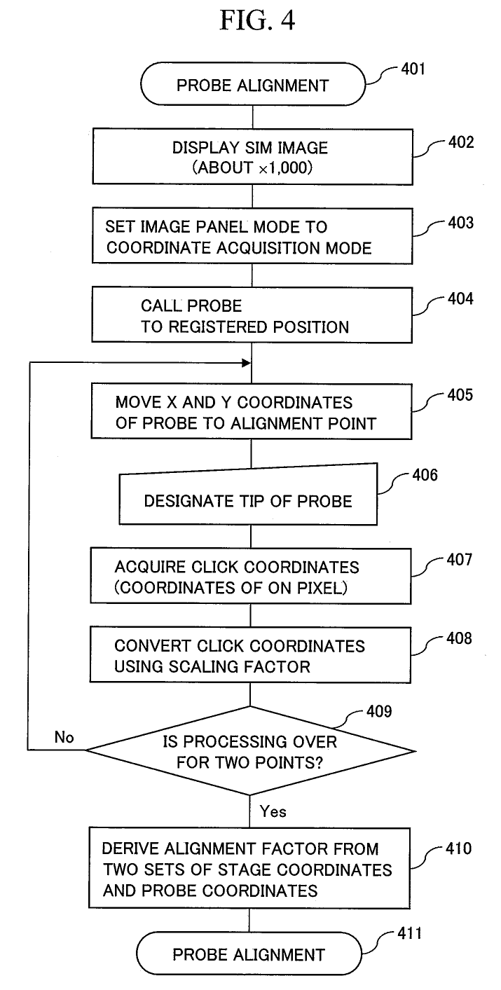

If the work of moving the sample stage and bringing a desired position to the center of the field of view is performed, the desired position may not fall at the center of field of view due to a stage stop error. Fine drive control for a probe is superior in precision to that for the sample stage, and it is better to control a probe for compensation for a shift from the center. A coordinate system of the stage drive control mechanism and one of the probe drive control mechanism do not always coincide with each other. Accordingly, a function of treating a shift of the sample stage from a target position as a drive control amount for a probe (referred to as probe alignment) is provided. An algorithm in FIG. 4 is used for probe alignment. The actual size of data represented by the field of view is determined by the scaling factor of an observation image. Assuming that the range of sample stage stop error falls within the field of view, it suffices to consider knowing at which position (pixel) of the field of view a sample target position is located and bringing a probe to the pixel. First, the procedure for manual alignment will be described. The scaling factor of an observation image is appropriately determined (402). An area for displaying the observation image is prepared such that-a pixel at a designated position can be recognized (403). The probe is called to a registered position (404). If a position to be used for alignment is determined in advance, the probe is moved to the position (405). An operator designates the position of the tip of the probe on the observation image using a pointing device such as a mouse (406). The pixel coordinates of the designated point are acquired (407), and the acquired pixel coordinates are converted using the image scaling factor (408). Although the number of measurement points is two in FIG. 4, multiple measurement points may be adopted. A relational expression for a linear transformation is derived from the relationship between coordinates held by the probe drive control mechanism and coordinates on the image (410). In actual probe drive control, the position of the tip of the probe can be acquired by performing the above-described linear transformation on the target pixel position, and the probe is driven using coordinates corresponding to the position. Although the operation of designating the tip of the prove (406) in FIG. 4 is manually performed, automation of probe alignment is realized by using the probe tip position recognizing method described above and fixing the position to which the probe is moved (alignment point).

The probe alignment is alignment of the probe with a displayed image. If the relationship between the displayed image and the sample stage is such that the tilt of the sample stage is negligible, the size of the image after conversion using the scaling factor and the amount of movement of the field of view caused by stage movement are almost equal, and the image and a sample stage drive axis are nearly orthogonal to each other, the result of the probe alignment can be directly used for alignment in the stage coordinate system. If a coordinate system for the displayed image and one for the sample stage cannot be considered to be the same, the stage alignment can be performed by processing similar to the probe alignment for the stage. The relationship between the probe and the stage can be easily derived from the relationship between the probe and the displayed image and that between the displayed image and the stage.

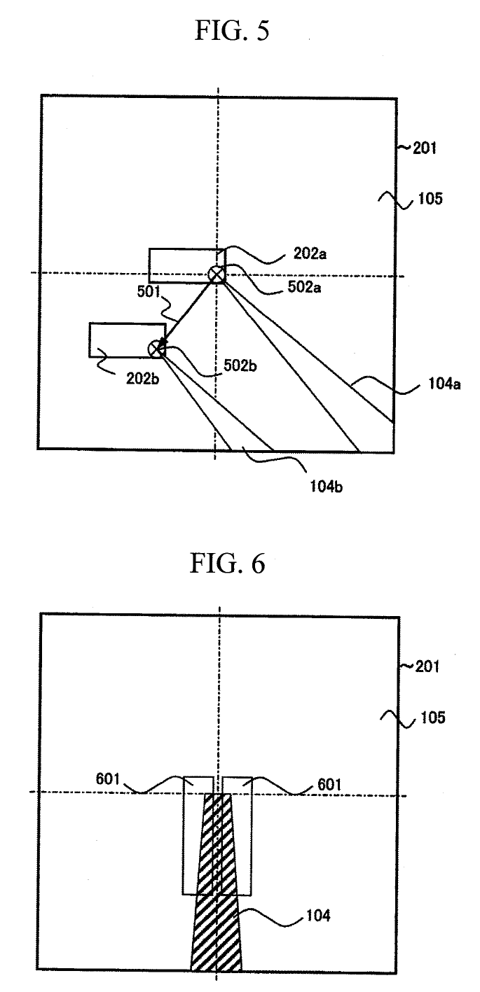

FIG. 5 is a schematic view showing the concept of pulling of a probe to a target position and shows a state in which a probe contact position is shifted from an ideal probe contact position at the time of contact of a probe with a micro-sample. Reference numeral 202a denotes an ideal micro-sample position. An ideal probe contact position 502a is located at the center of the field 201 of view. If an operation of moving the sample stage is performed, a micro-sample is not always brought to the ideal position. For example, if the micro-sample is observed at a position 202b, a position 502b serves as a probe contact position. Accordingly, a probe 104a is required to move to a probe 104b. If probe alignment has been performed, a direction and amount 501 of movement on an image can be replaced with coordinates for the probe drive control mechanism. A distance and direction of movement from near the point 502a to near the point 502b with a pointing device thus can be faithfully converted into a distance and direction of probe movement. A pulling function is realized by notifying the probe drive control mechanism of a corresponding value after designation of the start point 502a and end point 502b.

FIG. 6 is a schematic view showing a posture at the time of shaping the tip of a probe and processing patterns and shows an observation image at the time of shaping the tip of a probe which has been deformed and shortened and processing patterns necessary for shaping. A probe is rotationally displayed in a perpendicular direction using an observation image rotation function. This is to arrange processing patterns 601 to be perpendicular to the field 201 of view. Since the tip of the probe 104 has been deformed and shortened, it does not fall at the center of the image even if it is controlled to be driven to registered coordinates. Probe tip recognition is performed in this state, and the probe is controlled such that its tip falls at the center. This operation may be performed automatically or manually. After that, the tip of the probe is processed with the patterns 601 of a regular shape at a fixed position. The patterns of the regular shape are arranged with a minute gap between them to sharpen the tip of the probe.

Consider a function of making corrections in the X and Y directions, for control of a probe in a direction of height. The function is designed with a case in mind where the position of a probe in the Z-axis direction which is to move vertically is shifted in the X and Y directions on an observation image at the time of probe contact from a height Z to a target position and intended to compensate for such a shift.

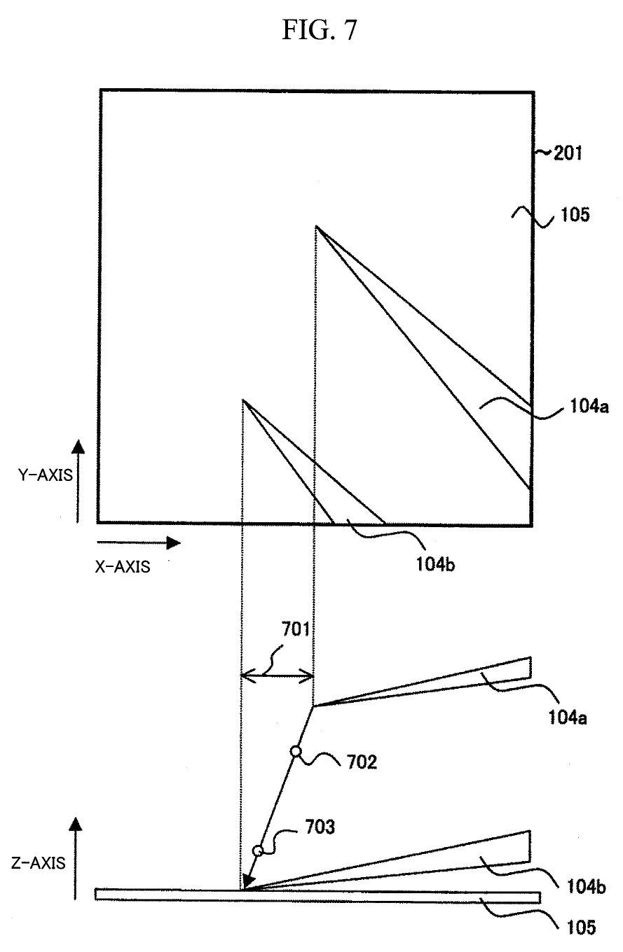

FIG. 7 is a schematic view showing the concept of a shift in probe Z movement and shows an example of the positional relationship between the probe 104a at the height Z and the probe 104b, which is an aspect when the probe 104 is moved vertically downward. An upper part of FIG. 7 shows an observation image as seen from the vertical direction. A lower part of FIG. 7 shows a state as seen from a side of the sample stage. A shift amount in the X-axis direction is denoted by reference numeral 701. Since X and Y shift amounts are each directly proportional to the magnitude of vertical movement of the probe, the tilt of a direction of movement is derived from X and Y displacement components of two arbitrary points like 702 and 703 in the Z direction. Probe height driving to the two points in the Z direction, recognition of the X and Y coordinates of the tip of the probe on the field (201) of view at each position, and calculation of the tilt for correction are automatically performed.

To directly move a probe from a height to a target position in one stroke, the height of the target position is subtracted from the height, and the remainder is multiplied by the amount of tilt, thereby calculating a displacement. The probe is shifted by the displacement in the opposite direction and is moved downward. With this operation, the probe arrives at the target position. When the probe is to be manually and gradually moved downward, the probe is moved downward in a stepwise manner while performing X shift driving and Y shift driving per unit Z distance. To move the probe downward while manually checking the probe, X and Y shift amounts per unit Z distance are supplied to the probe drive control mechanism without change as the ratio between a Z lowering speed and an X movement speed and that between the Z lowering speed and a Y movement speed, and X shift driving and Y shift driving corresponding to a probe lowering speed are simultaneously performed.

To eliminate a positional shift of a probe within an observation image in drive control of the probe in the direction of height, shift amounts in the X and Y directions on an observation image are measured at each of two or more heights in advance, the degree of shift when controlling the probe to a target height is derived, and the degree of shift is added in a direction which compensates for a shift. This makes it possible to control to drive the probe to the target position.

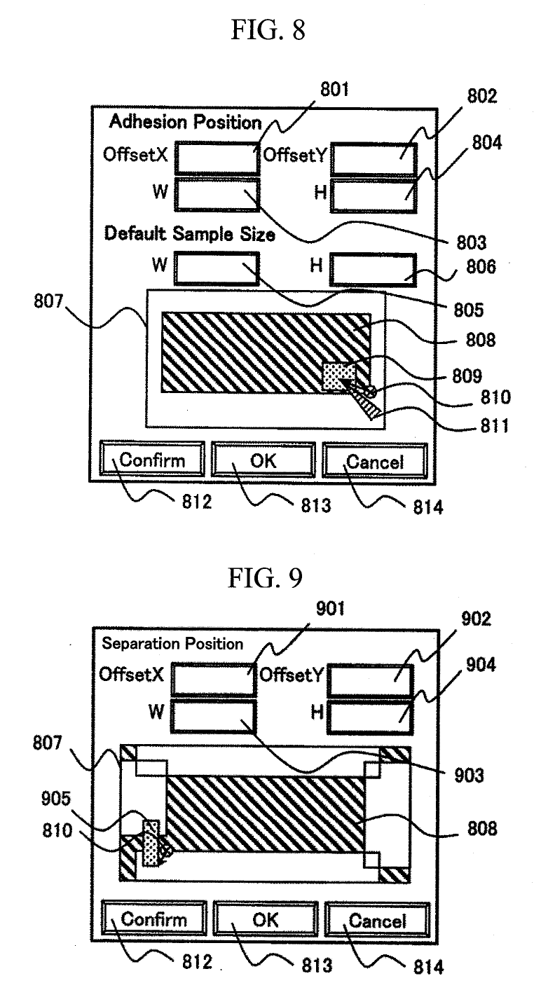

A mechanism for automating a series of processes from probe contact to lifting of a micro-sample will be described. FIGS. 8 and 9 are examples of screens for setting conditions defining an ideal probe contact position (also serving as an adhesion position) for a micro-sample and a position at which a micro-sample is cut out from a sample. In these screens, a micro-sample is represented by a rectangle 808 which is the shape of its surface, and positions (801, 802, 901, and 902) from a corner 810 of the micro-sample and processing dimensions (803, 804, 903, and 904) are defined. Conditions for deposition in which a probe is caused to adhere to the surface of the micro-sample and conditions for processing in which the micro-sample is separated from the sample are also defined (not shown). Since the positions are defined using the corner 810 of the micro-sample as a reference, the same conditions can be used for micro-samples with different sizes. Accordingly, these conditions are set such that they can be called up and used again when needed. Note that the conditions can be individually set for each micro-sample.

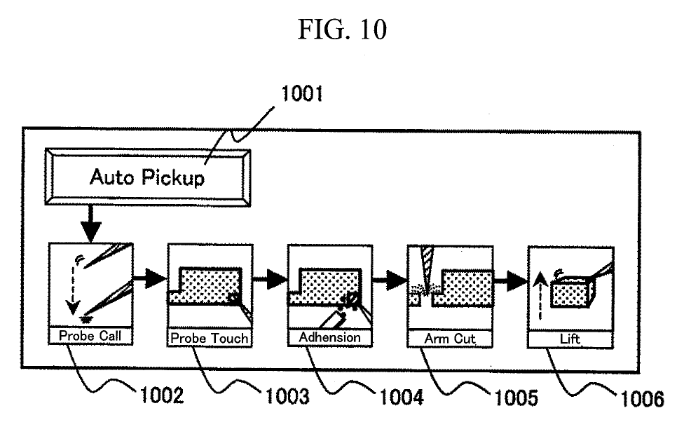

FIG. 10 is an example of an operation screen for performing an automatic pickup process. The operation screen has a function of automatically performing a process of bringing a probe into contact with the surface of a minute sample, causing the tip of the probe to adhere to the minute sample by deposition, cutting a connection between the minute sample and a sample using a processing function, and controlling to drive the probe upward (referred to as an automatic pickup function).

After completion of positioning of a micro-sample, a series of processes is performed by pressing an Auto Pickup button 1001. More specifically, a probe is called, the probe is brought into contact with a micro-sample at a defined position, deposition is performed under defined conditions to cause the probe to adhere to the micro-sample, a connection between a sample and the micro-sample is cut by processing, and the probe is lifted. In the operation screen, the progress of the series of processes is represented by conceptual diagrams (1002 to 1006), and one of the processes in progress is visually enhanced.

This embodiment achieves advantages such as an increase in the success rate of sampling, a reduction in mental burden, an increase in the lifetime of a probe, and elimination of personality. A series of operations from contact of a probe with a micro-sample to separation of the micro-sample from a sample can be automatically performed. It is further possible to easily shape a deformed probe.

What is claimed is:

1. A charged particle beam apparatus comprising:
a charged particle beam generating section and a charged particle beam irradiating optical system;
a stage on which a sample is mounted and which can move below a charge particle beam and a control section which drives the stage;
an electron detecting section which detects a particle emitted from the sample;
a control section which acquires an observation image by synchronizing a detection signal from the electron detecting section and charged particle beam scanning; and
a probe for cutting out a minute sample from the sample and a probe drive control section which controls driving of the probe,
wherein the apparatus is configured to acquire positional information of a tip of the probe while observing the tip of the probe and associate a coordinate system recognized by the probe drive control section with the positional information.

2. The charged particle beam apparatus according to claim 1, wherein control of a position of the tip of the probe using a same coordinate system as a coordinate system of coordinates of the stage is allowed by associating the coordinates of the stage, on which the sample is mounted, with coordinates recognized by the probe drive control section.

3. The charged particle beam apparatus according to claim 2, wherein an operation of designating a direction and a magnitude on the observation image is performed using a pointing device, a position of the probe is changed by a same magnitude and in a same direction as the operation on the image, and the position of the probe is moved to a desired position while observing the tip of the probe on the image.

4. The charged particle beam apparatus according to claim 2, wherein a positional relationship between the position of the tip of the probe and the observation image is maintained, and measurement of a displacement and feedback of the displacement for coordinates of the probe are performed even if a shape of the tip of the probe changes due to factors including probe replacement, probe break, and probe deformation.

5. The charged particle beam apparatus according to claim 2, wherein a shape of the tip of the probe which has been deformed is shaped by precisely arranging the tip of the probe within an observation area and applying the charged particle beam to an area of a regular shape.

6. The charged particle beam apparatus according to claim 2, wherein recognition of the tip of the probe and association of the control section for stage driving with the coordinates recognized by the probe drive control section are automatically performed, and the association is held and used for probe control.

7. The charged particle beam apparatus according to claim 1, wherein a search area is limited based on recognition of the tip of the probe and storage of coordinates of the probe in tip recognition at another time.

8. The charged particle beam apparatus according to claim 2, wherein shift amounts in X and Y directions on the observation image are measured in advance at at least two heights, the degree of shift when controlling the probe to a target height is derived, and the probe is controlled to be driven to a target position based on the degree of shift.

9. The charged particle beam apparatus according to claim 8, wherein the probe is brought into contact with a surface of a minute sample, the tip of the probe is caused by deposition to adhere to the minute sample, a connection between the minute sample and a sample is cut, and the minute sample is picked up by controlling to drive the probe.
